(19) United States
(12) Patent Application Publication
(10) Pub. No.: US 2007/0062396 A1
(43) Pub. Date: Mar. 22, 2007

(54) Imprinting apparatus and imprinting method

(75) Inventors: Mitsuru Takai, Tokyo (JP); Kazuhiro Hattori, Tokyo (JP); Minoru Fujita, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, TOKYO (JP)

(21) Appl. No.: 10/556,052

(22) PCT Filed: Apr. 28, 2004
(86) PCT No.: PCT/JP04/06217

§ 371 Date: Nov. 8, 2005

(30) Foreign Application Priority Data
May 9, 2003 (JP) 2003-131661

(51) Int. Cl. B41K 1/56

(52) U.S. Cl. 101/406

(57) ABSTRACT

An imprinting apparatus according to the present invention is configured to be capable of removing a stamper having one surface thereof formed with a concave/convex portion and having flexibility, from a resist layer to which shapes of the concave/convex portion of the stamper have been transferred by pressing the concave/convex portion of the stamper against the resist layer on a disk-shaped substrate. The imprinting apparatus comprises a suction device (a suction section, an air pump, and a restrictor) configured to be capable of sucking a predetermined part of the other surface of the stamper to thereby remove the predetermined part from the resist layer such that a removal completion range of the stamper can be gradually expanded from a state where the predetermined part is removed from the resist layer by the suction device.

### TECHNICAL FIELD

The present invention relates to an imprinting apparatus which is configured to be capable of removing a stamper of which the shapes of concave/convex portion have been transferred to a resin layer formed on a substrate, and an imprinting method therefor.

### BACKGROUND ART

Conventionally, in processes for manufacturing e.g., semiconductor devices and recording media, there has been known, as a method of forming a nanometer-sized fine concave/convex pattern in a resin layer on a substrate, imprint lithography (hereinafter referred to as “the imprinting method”) in which a stamper (template or mold) having a concave/convex portion formed thereon is pressed against a resin layer by a pressing machine or the like to thereby transfer the shapes of concave/convex portion of the stamper. In the imprinting method, first, the resin layer is formed on the substrate, for example, (e.g., by applying a resist material to the substrate, in the form of a thin film). Then, the stamper made of a metal material and having one surface thereof formed with the concave/convex portion is attached to a clamp of the pressing machine, in a state set in a stamper holder, and the substrate is placed on a bed of the pressing machine with its surface formed with the resin layer facing upward. Then, in a state in which the resin layer is heated, the clamp is moved downward by operating the pressing machine, to thereby press the concave/convex portion of the stamper against the resin layer. Thus, the convex portions of the concave/convex portion of the stamper are pushed into the resin layer, whereby the shapes of the concave/convex portion of the stamper are transferred to the resin layer. Subsequently, the clamp of the pressing machine is moved upward after the temperature of the resin layer is lowered, whereby the stamper is removed from the resin layer. Thus, formation of the concave/convex pattern is completed.

In the above conventional imprinting method, however, when the clamp of the pressing machine is moved upward, the whole of the stamper mounted on the clamp is moved upward (removed) from the resin layer almost simultaneously. This raises a problem that a very large force is necessitated to remove the stamper which is in intimate contact with the resin layer from the resin layer at the start of upward motion of the clamp (at the start of removal of the stamper). Further, the whole of the stamper is removed from the resin layer all at once, and hence it is difficult for air to flow in between the stamper and the resin layer. This can cause breakage of the concave/convex pattern due to removal of the resist material forming the resin layer from the substrate together with the stamper, in its state attracted to the stamper. To overcome this problem, various types of stamper-removing methods are devised which make it possible to remove the stamper with a small force while avoiding the breakage of the concave/convex pattern during removal of the stamper.

For example, a manufacturing apparatus (80) disclosed in Japanese Laid-Open Patent Publication (Kokai) No. H09-219041 is comprised of a horizontal base (30) for attracting and holding a stamper (8), and a removal plate (60) for attracting and holding a substrate (1) coated with a photocurable resin (3) (formed with a resin layer). The manufacturing apparatus (80) is further comprised of a center pin (40) which is mounted at a central portion of the horizontal base, in a manner vertically movable toward the removal plate, and is engaged with the rim of a central hole (1h) of the substrate when moved upward, to thereby remove the substrate (resin layer) from the stamper on the horizontal base. On the other hand, the stamper, which is a mold for forming micro asperities such as data-recording pits and grooves in the resin layer on the substrate, is in the form of a thin film made of a magnetic metal, and has a central portion thereof formed with a central hole (8h) into which the center pin can be inserted.

When the concave/convex pattern is formed in the resin layer on the substrate by the manufacturing apparatus, first, the photocurable resin is applied to the substrate to thereby form the resin layer. Then, the substrate is caused to be held by the removal plate with a surface of the substrate formed with the resin layer facing downward, and the stamper is set on the horizontal base with the concave/convex portion facing upward. Subsequently, the removal plate having the substrate held thereon is moved downward toward the horizontal base, thereby the resin layer is pressed against the stamper on the horizontal base. After that, by irradiation of ultraviolet rays from a back surface side of the substrate, the resin layer having the shapes of the concave/convex portion of the stamper transferred thereto is formed on the substrate (between the substrate and the stamper). Then, the substrate is caused to be attracted to the removal plate by evacuating air between the removal plate and the substrate. Thereafter, the center pin is moved upward while the whole of the substrate is being sucked toward the removal plate by exhausting air within a first hermetically sealed space (51) through an exhaust port (91) of the removal plate, thereby a portion of the substrate in the vicinity of the rim of the central hole (central portion of the substrate) is pushed up toward the removal plate. At this time, the stamper is attracted and held by the horizontal base with a magnetic force, and hence the central portion of the substrate (resin layer) pushed up by the center pin is removed from the stamper. Then, the removal plate having the substrate attracted thereto is moved upward. At this time, a range of removal of the substrate (resin layer) from the stamper (range removed from the stamper) is gradually expanded from the central portion of the substrate where removal from the stamper has already been completed, toward the outer periphery of the substrate. As a result, the removal of the stamper from the substrate is completed. At this time, the gradual expansion of the removal range allows air to smoothly flow in between the stamper and the resin layer, which results in avoidance of breakage of the concave/convex pattern. Further, compared with the method of removing the whole of the stamper from the resin layer all at once, the above method gradually expands the removal range, thereby making it possible to remove the stamper from the resin layer with a relatively small force.

### DISCLOSURE OF THE INVENTION

From the study of the above-described manufacturing apparatus, the present inventors found out the following problem to be solved: In the conventional manufacturing apparatus, when the stamper is removed from the substrate (resin layer) on which the concave/convex pattern has been formed (to which the shapes of the concave/convex portion have been transferred), first, the rim of the central hole of the substrate (central portion of the substrate) is pushed up with the center pin to remove the central portion of the substrate from the stamper. Therefore, in the manufacturing apparatus, it is necessary to form a central hole for inserting the center pin at the central portion of the stamper. When a stamper having no central hole formed therein (stamper without a hole) is used, it is impossible to push up the substrate with the center pin. Therefore, the conventional manufacturing apparatus suffers from the problem that the shapes of asperities of the concave/convex portion cannot be transferred if a stamper without a hole is employed.

The present invention has been made to solve the above described problem, and it is a main object thereof to provide an imprinting apparatus and an imprinting method which are capable of easily removing a stamper without a hole, from a resin layer, without causing breakage of a concave/convex pattern.

The imprinting apparatus according to the present invention is configured to be capable of removing a stamper having one surface thereof formed with a concave/convex portion and having flexibility, from a resin layer to which shapes of the concave/convex portion have been transferred by pressing the concave/convex portion of the stamper against the resin layer on a substrate, and comprises a suction device configured to be capable of sucking a predetermined part of the other surface of the stamper to thereby remove the predetermined part from the resin layer, such that a removal completion range of the stamper can be gradually expanded from a state where the predetermined part is removed from the resin layer by the suction device.

Further, in the imprinting method according to the present invention, when a stamper having one surface thereof formed with a concave/convex portion and having flexibility is removed from a resin layer to which shapes of the concave/convex portion have been transferred by pressing the concave/convex portion of the stamper against the resin layer on a substrate, a removal completion range of the stamper is gradually expanded after a predetermined part of the other surface of the stamper is removed from the resin layer by sucking the predetermined part.

According to the imprinting apparatus and the imprinting method, the predetermined part of the other surface of the stamper is caused to be sucked by the suction device such that the removal completion range of the stamper is gradually expanded from the state where the predetermined part is removed from the resin layer by the suction device, whereby it is possible to easily remove a stamper without a hole from the resin layer with a relatively small force, unlike a removing method of removing the whole of a stamper from a resin layer all at once using a pressing machine, for example. Further, as gradual expansion of the removal completion range (suction range) makes it possible to remove the stamper from the resin layer without applying an undue force to the resin layer, it is possible to avoid breakage of a concave/convex pattern during the removal of the stamper. Therefore, e.g., when the substrate is subjected to the etching process using the resin layer as a mask, it is possible to reliably protect a surface of the substrate which is to be protected by the mask (resin layer).

In this case, it is preferable that the suction device is configured to be capable of sucking a central portion of the other surface of the stamper as the predetermined part. This configuration makes it possible to prevent inconvenience from being caused during recording and reproducing of information even if small defects have occurred in a central portion of an information recording medium as a body of rotation, so that even if the concave/convex pattern on a central portion of the substrate is slightly damaged in an initial stage of removal operation for removing the stamper, it is possible to manufacture information recording media enabling accurate reading and writing of information.

Further, it is preferable that the suction device is configured to be capable of gradually expanding the removal completion range toward an outer periphery of the stamper by gradually expanding a suction range of the stamper toward the outer periphery in multiple steps or steplessly in a state where the suction device has sucked the central portion thereto. With this configuration, even if a very small breakage which presents almost no problem in use has occurred in the concave/convex pattern during removal of the stamper, it is possible to preserve uniformity of the state of occurrence of the small breakage at portions equal in radial distance from the central portion of the substrate. This makes it possible to form a concave/convex pattern suitable for manufacturing information recording media as bodies of rotation, such as magnetic disks, optical disks, and magneto-optical disks.

Furthermore, it is preferable that the suction device comprises a box body with one surface thereof opened, and a restrictor having a plurality of restriction blades and mounted on the box body in a manner closing the one surface of the box body, and that the suction device is configured to be positioned above the stamper during removal of the stamper, sucks the central portion of the stamper by sucking gas between the stamper and the restriction blades through an aperture hole of the restrictor, gradually expands a diameter of the aperture hole by sliding the restriction blades in the state where the suction device has sucked the central portion of the stamper thereto, whereby the suction device is capable of gradually expanding the suction range toward the outer periphery of the stamper. Although relatively simple, this configuration of the apparatus makes it possible to reliably and easily adjust the removal completion range of the stamper.

Further, it is preferable that the suction device is configured to be capable of sucking at least a portion of the outer periphery of the other surface of the stamper as the predetermined part. With this configuration, similarly to the above-described imprinting apparatus, it is possible to remove the stamper with a small force, and avoid breakage of the concave/convex pattern during the removal of the stamper.

Furthermore, it is preferable that the suction device is configured to be capable of gradually expanding the removal completion range toward the central portion of the stamper by gradually expanding a suction range of the stamper toward the central portion in multiple steps or steplessly in a state where the suction device has sucked the outer periphery thereto. With this configuration, even if a very small breakage which presents almost no problem in use has occurred in the concave/convex pattern during removal of the stamper, it is possible to preserve uniformity of the state of occurrence of the small breakage at portions equal in radial distance from the central portion of the substrate. This makes it possible to form a concave/convex pattern suitable for manufacturing information recording media as bodies of rotation, such as magnetic disks, optical disks, and magneto-optical disks.

Further, it is preferable that the imprinting apparatus comprises a suction cup as the suction device, and a moving mechanism for moving the suction cup, and that the moving mechanism is configured such that the moving mechanism causes the suction cup to suck the predetermined part by pressing the suction cup against the other surface of the stamper, to thereby remove the predetermined part from the resin layer, and moves the suction cup in a direction away from the resin layer from the state where the suction cup has removed the predetermined part from the resin layer, whereby the moving mechanism is capable of gradually expanding the removal completion range of the stamper. With this configuration, since the suction cup is inexpensive, the imprinting apparatus can be manufactured sufficiently inexpensively.

It should be noted that the present disclosure relates to the subject matter included in Japanese Patent Application No. 2003-131661 filed on May 9, 2003, and it is apparent that all the disclosures therein are incorporated herein by reference.

### BRIEF DESCRIPTION OF DRAWINGS

FIG. 1 is a block diagram showing the arrangement of an imprinting apparatus 1 according to an embodiment of the present invention.

FIG. 2 is a side cross-sectional view showing the construction of the imprinting apparatus 1 according to the embodiment of the present invention.

FIG. 3 is a plan view showing a sliding state of restriction blades 6a, 6a, . . . of a restrictor 6 (opening state of an aperture hole) and a suction range A1 of a stamper 61 associated with the sliding state of restriction blades 6a, 6a, . . . shown in a left half of FIG. 3.

FIG. 4 is a side cross-sectional view showing a state of the imprinting apparatus in which a central portion of the stamper 61 is sucked by a suction section 4.

FIG. 5 is a cross-sectional view of the stamper 61, a resist layer 52, and a disk-shaped substrate 51, within the suction range A1.

FIG. 6 is a cross-sectional view of the stamper 61, the resist layer 52, and the disk-shaped substrate 51, within a nonsuction range A2.

FIG. 7 is a side cross-sectional view showing a state of the imprinting apparatus in which the suction range A1 of the stamper 61 sucked by the suction section 4 is expanded from the FIG. 4 state toward the outer periphery of the stamper 61.

FIG. 8 is a side cross-sectional view showing a state of the imprinting apparatus in which the suction range A1 of the stamper 61 sucked by the suction section 4 is further expanded from the FIG. 7 state toward the outer periphery of the stamper 61.

FIG. 9 is a side cross-sectional view showing a state of the imprinting apparatus in which the suction range A1 sucked by the suction section 4 is still further expanded to suck the whole area of the stamper 61.

FIG. 10 is a diagram showing results of inspections of the resist layer 52 from which the stamper 61 is removed by various removing methods, and quality determinations of the resist layer 52.

FIG. 11 is a block diagram showing the arrangement of an imprinting apparatus 1A according to another embodiment of the present invention.

FIG. 12 is a side cross-sectional view showing a state of the imprinting apparatus in which the outer periphery of the stamper 61 is sucked by a suction cup 14 of the imprinting apparatus 1A.

FIG. 13 is a side cross-sectional view showing a state of the imprinting apparatus in which the stamper 61 sucked by the suction cup 14 of the imprinting apparatus 1A is removed from the resist layer 52.

### BEST MODE FOR CARRYING OUT THE INVENTION

Hereafter, an imprinting apparatus and an imprinting method according to a preferred embodiment of the present invention will be described with reference to the accompanying drawings.

First, a description will be given of the arrangement of the imprinting apparatus 1 according to the present invention.

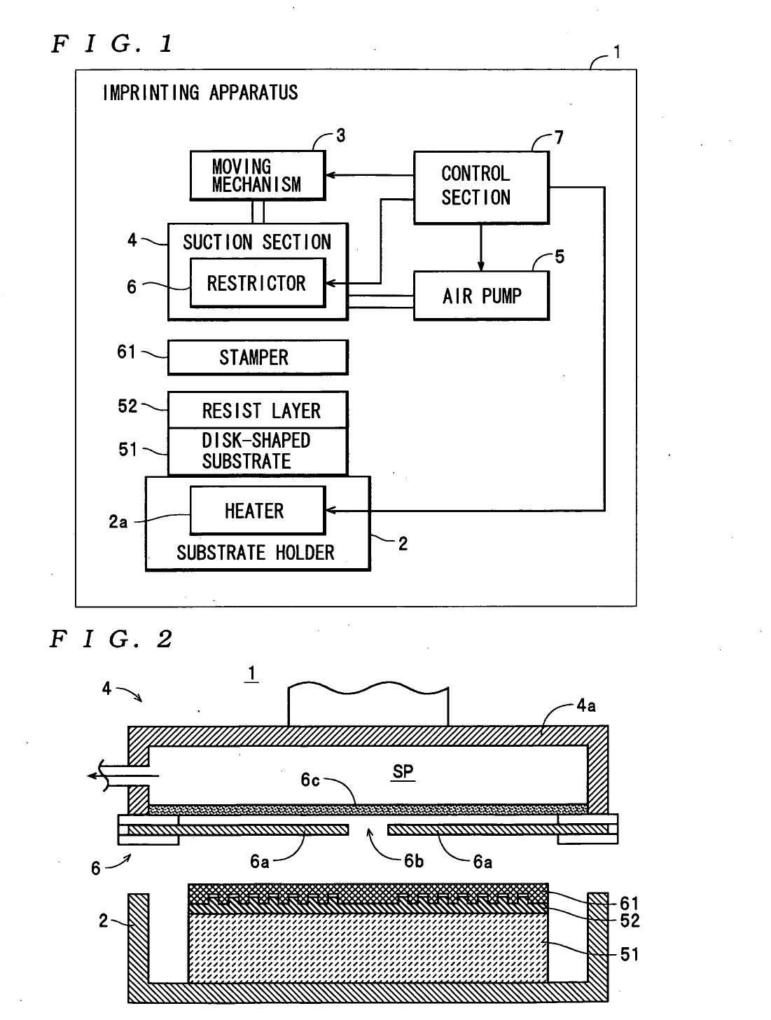

The imprinting apparatus 1 shown in FIG. 1 is configured such that a mask (e.g., a mask of a photoresist material) for forming a concave/convex pattern can be formed on a disk-shaped substrate 51 for an information recording medium (e.g., for a discrete track-type recording medium) before a nanometer-sized fine concave/convex pattern is formed on a surface of the disk-shaped substrate 51. More specifically, the imprinting apparatus 1 includes a pressing machine, not shown, and is configured such that a stamper 61 can be pressed against a resist layer 52 on the disk-shaped substrate 51 by the pressing machine, to thereby transfer the shapes of concave/convex portion of the stamper 61 to the resist layer 52 (to form a concave/convex pattern). Further, the imprinting apparatus 1 includes a substrate holder 2, a moving mechanism 3, a suction section 4, an air pump 5, a restrictor 6, and a control section 7, and is configured such that the stamper 61 pressed against the resist layer 52 on the disk-shaped substrate 51 can be removed from the resist layer 52.

In this case, the disk-shaped substrate 51 is formed e.g., by a glass disk having a diameter of 2.5 inches. As shown in FIG. 2, the disk-shaped substrate 51 is configured such that a positive resist is applied to a surface thereof by the spin coating method to form the resist layer 52 (a resin layer in the present invention) having a thickness of approximately 75 nm on the surface. It should be noted that in figures with reference to which the present embodiment is described, the thicknesses of the disk-shaped substrate 51 and the resist layer 52 are illustrated in an exaggerated manner for ease of understanding of the present invention. On the other hand, the stamper 61 for use in forming a concave/convex pattern in the resist layer 52 is a nickel stamper without a hole, for example, which has flexibility and a thickness of approximately 300 μm with one surface thereof (lower surface, as viewed in FIG. 2) formed with a concave/convex portion. The stamper 61 is formed by an electron beam lithography method or the like such that a ratio between the width of concave portions and that of convex portions in the concave/convex portion is equal to 1:1 (in this case, a pitch=150 nm, for example). The concave/convex portion of the stamper 61 is pressed against the resist layer 52 on the disk-shaped substrate 51 by the pressing machine, to thereby form the concave/convex pattern in the resist layer 52 (transfer the shapes of the concave/convex portion to the resist layer 52).

As shown in FIG. 2, the substrate holder 2 is formed into a box body with an open top, and configured such that the disk-shaped substrate 51 can be placed on an inner bottom surface thereof. Further, as shown in FIG. 1, the substrate holder 2 includes a heater 2a that heats the disk-shaped substrate 51 under the control of the control section 7. The moving mechanism 3 moves the suction section 4 and the restrictor 6 under the control of the control section 7. As shown in FIG. 2, the suction section 4 has a box body 4a with an open bottom, and the restrictor 6 is attached to the open bottom (one surface in the present invention) in a manner closing the same. Further, the suction section 4 is configured to be capable of sucking and holding (attracting and holding) the stamper 61 by sucking air (gas) within a space SP defined by the box body 4a and the restrictor 6 (restriction blades 6a, 6a, . . . and an upward motion-restricting plate 6c, described later) using the air pump 5. The air pump 5 sucks air within the suction section 4 (within the space SP) under the control of the control section 7.

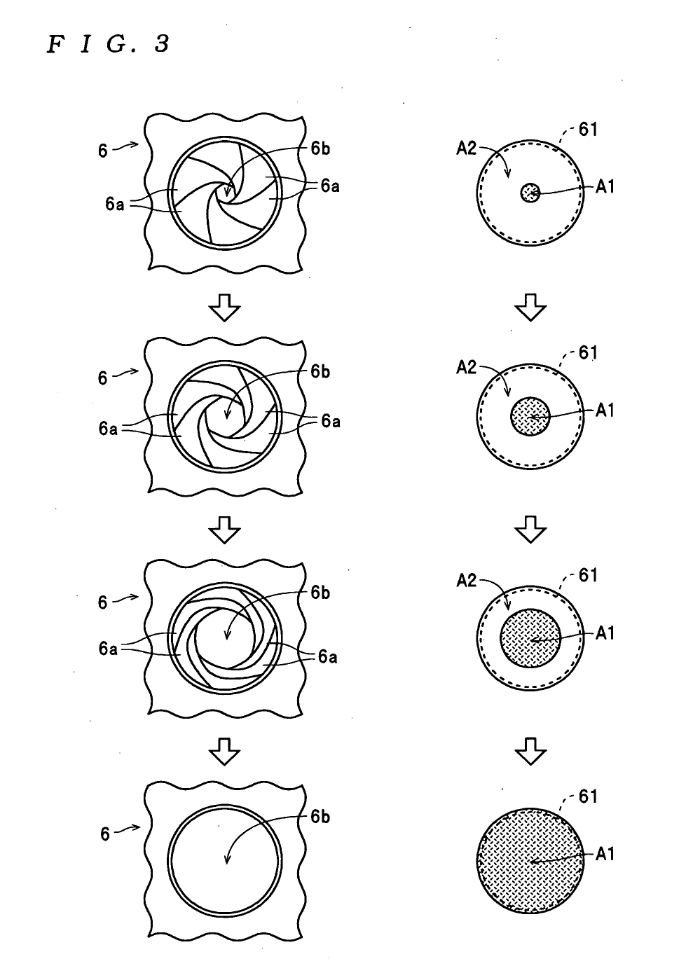

As shown in a left half of FIG. 3, the restrictor 6 includes a plurality of restriction blades 6a, 6a, . . . , and is configured to be capable of adjusting the diameter of an aperture hole 6b by sliding the restriction blades 6a, 6a, . . . under the control of the control section 7. Further, as shown in FIG. 2, the restrictor 6 includes the upward motion-restricting plate 6c, which is formed into a disk shape with a porous material and disposed within the box body 4a in parallel with the restriction blades 6a, 6a, . . . . In this case, during removal of the stamper 61 from the resist layer 52, the restrictor 6 is moved by the moving mechanism 3 to a position over the stamper 61 together with the box body 4a of the suction section 4. Further, in the state where the restrictor 6 has been moved to the position over the stamper 61, as the air within the space SP is sucked by the air pump 5 air between the restriction blades 6a, 6a, . . . and the other surface of the stamper 61 is sucked through the aperture hole 6b and a myriad of holes of the upward motion-restricting plate 6c, thereby the stamper 61 is removed from the resist layer 52 in a manner drawn up into the aperture hole 6b, and drawn to the upward motion-restricting plate 6c. At this time, since the upward motion-restricting plate 6c is disposed such that the stamper 61 drawn thereto can be brought into abutment therewith, it is possible to avoid the stamper 61 being drawn to a position higher than required. Further, the restrictor 6 slides the restriction blades 6a, 6a, . . . to gradually expand the diameter of the aperture hole 6b, whereby as shown in a right half of FIG. 3, the restrictor 6 gradually increases a range of suction of the stamper 61 (hereinafter referred to as “the suction range A1”) to gradually increase a removal completion range of the stamper 61 (range that substantially matches the suction range A1, in this case). It should be noted that in the imprinting apparatus 1, the suction section 4, the air pump 5, and the restrictor 6 together form the suction device for the present invention.

The control section 7 controls heating of the disk-shaped substrate 51 by the heater 2a, and moves the suction section 4 and so forth by controlling the operation of the moving mechanism 3. Further, the control section 7 controls the suction of air within the space SP by the air pump 5, and the adjustment of the suction range A1 by controlling a sliding state of the restriction blades 6a, 6a, . . . of the restrictor 6.

Next, a method of forming a mask made of the resist layer 52 on the disk-shaped substrate 51 will be described with reference to drawings. It should be noted that the step of applying the resist layer 52 to the one surface of the disk-shaped substrate 51 and the step of manufacturing the stamper 61 are assumed to have been completed.

First, the stamper 61 is mounted on a clamp of the pressing machine in a state where the stamper 61 is set in a stamper holder (not shown), and the substrate holder 2 is placed on a bed of the pressing machine in a state where the disk-shaped substrate 51 is set in the substrate holder 2, with the surface thereof formed with the resist layer 52 facing upward. At this time, the suction section 4 has been moved to a predetermined retracted position by the moving mechanism 3. Then, the control section 7 causes the heater 2a to heat the disk-shaped substrate 51. In doing this, the heater 2a heats the disk-shaped substrate 51 such that the temperature of the resist layer 52 becomes e.g., approximately 170° C. (temperature equal to or higher than the glass transition temperature of the resist layer 52). Subsequently, the control section 7 causes the pressing machine to operate to move the clamp downward, to thereby press the concave/convex portion of the stamper 61 against the resist layer 52 of the pressing machine. In doing this, the stamper 61 is pressed against the resist layer 52 by the pressing machine e.g., with a force of approximately 170 kgf/cm². Thus, the convex portions of the concave/convex portion of the stamper 61 are pushed into the resist layer 52, whereby a concave portions are formed in the resist layer 52.

Then, the stamper 61 of which the convex portions have been pushed into the resist layer 52 (the shapes of the concave/convex portion have been transferred to the resist layer 52) is removed from the resist layer 52. More specifically, first, the clamp of the pressing machine is moved upward after causing the stamper 61 to be released from holding by the stamper holder. At this time, since the concave/convex portion of the stamper 61 has been pushed into the resist layer 52 on the disk-shaped substrate 51 to cause the stamper 61 to be brought into intimate contact with the resist layer 52, the stamper 61 released from holding by the stamper holder is left behind on the substrate holder 2 together with the disk-shaped substrate 51 (resist layer 52). Then, as shown in FIG. 2, the control section 7 causes the moving mechanism 3 to move the suction section 4 to a position over the stamper 61. At this time, as shown in an uppermost left portion of FIG. 3, the restriction blades 6a, 6a, . . . of the restrictor 6 are positioned so that the aperture hole 6b of the restrictor 6 has the smallest diameter. Subsequently, the control section 7 causes the heater 2a to decrease the degree of heating of the disk-shaped substrate 51 and hold the temperature of the resist layer 52 at approximately 50° C., for example.

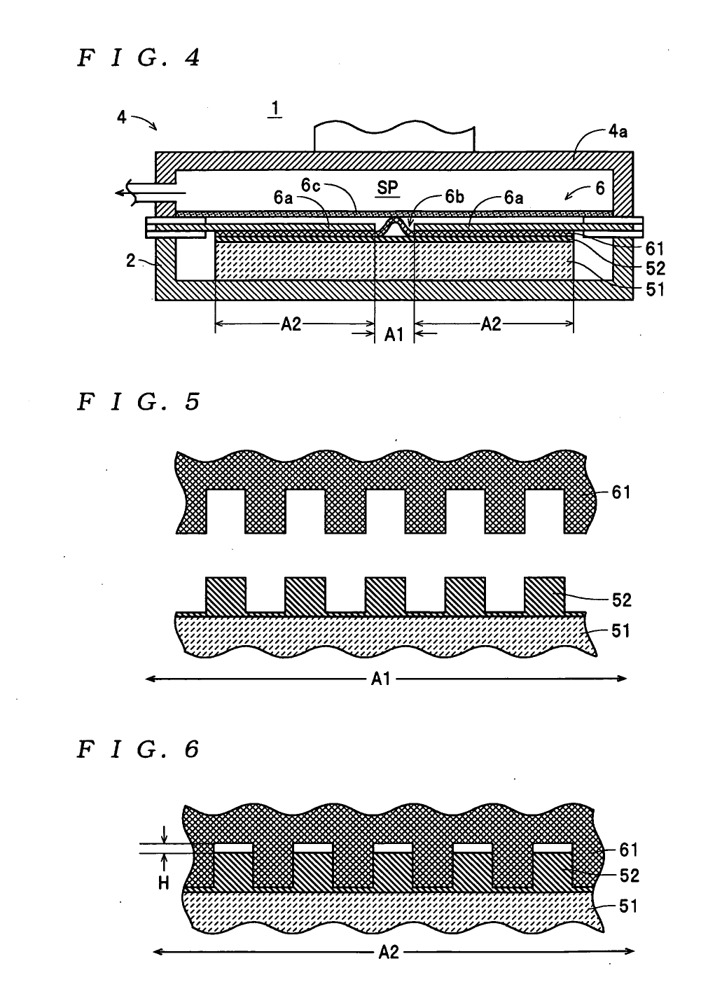

Then, the control section 7 causes the air pump 5 to start suction of air within the space SP while causing the moving mechanism 3 to move the suction section 4 downward toward the stamper 61. At this time, air within the space SP is sucked by the air pump 5, thereby air between the restriction blades 6a, 6a, . . . of the restrictor 6 and the other surface of the stamper 61 is sucked through the aperture hole 6b into the space SP. Further, when the restriction blades 6a, 6a, . . . approach a position very close to the stamper 61 along with the downward motion of the suction section 4, the central portion (an example of “the predetermined part” in the present invention) of the stamper 61 is drawn (sucked) via the aperture hole 6b toward the space SP by the suction force of the air pump 5, as shown in FIG. 4. At this time, as shown in FIG. 5, in the suction range A1 where the central portion of the stamper 61 is sucked toward the space SP via the aperture hole 6b, a portion of the stamper 61 is sucked toward the space SP to be removed (peeled) from the resist layer 52, and as shown in FIG. 4, the portion removed from the resist layer 52 is drawn to the upward motion-restricting plate 6c. At this time, as shown in FIG. 6, a gap having a height H exists between the concave portions of the stamper 61 and a surface of the resist layer 52 in a range of the stamper 61 not sucked toward the space SP (range covered with the restriction blades 6a, 6a, . . . : hereinafter referred to as “the nonsuction range A2”). Therefore, when the stamper 61 is removed from the resist layer 52 within the suction range A1, ambient air is allowed to smoothly flow in between the stamper 61 and the resist layer 52 within the suction range A1, through the gap between the stamper 61 and the resist layer 52 within the nonsuction range A2. This makes it possible to remove the stamper 61 from the resist layer 52 with a relatively small force, thereby making it possible to avoid the concave/convex pattern being broken in the suction range A1.

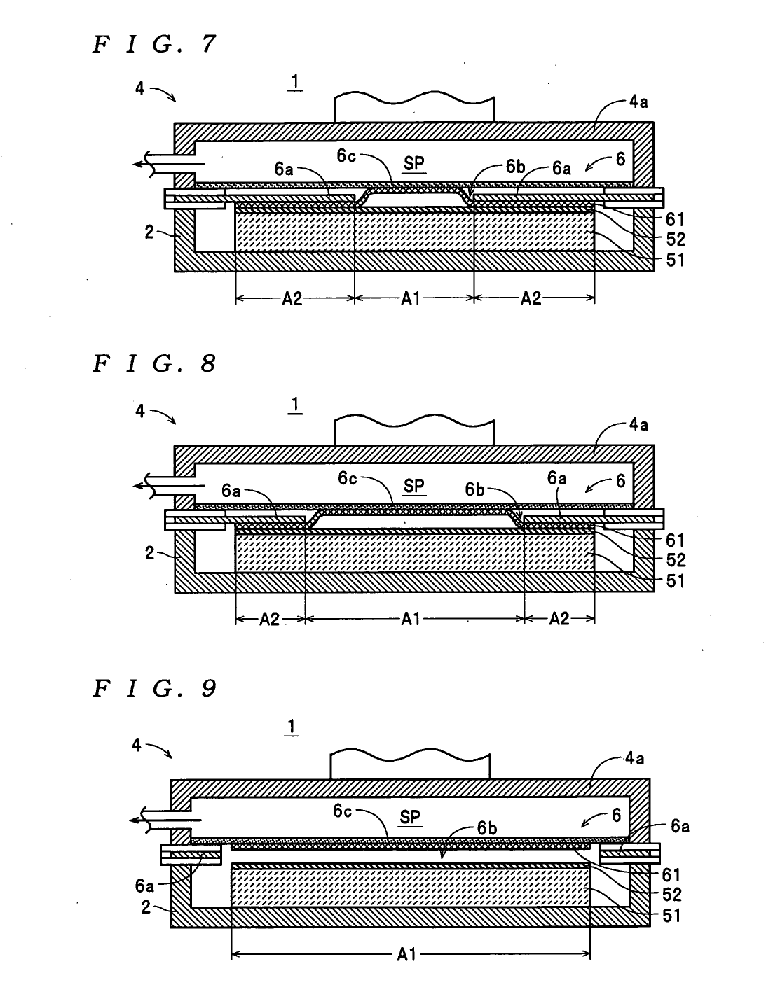

Subsequently, the control section 7 causes the restrictor 6 to slide the restriction blades 6a, 6a, . . . to gradually expand the diameter of the aperture hole 6b steplessly. At this time, the restrictor 6 slides the restriction blades 6a, 6a, . . . so that the rate of expansion of the diameter of the aperture hole 6b becomes approximately 1 mm/sec, by way of example. It should be noted that the rate of expansion of the diameter of the aperture hole 6b is not limited to the above example. Further, as shown in the right half of FIG. 3, in accordance with the expansion of the diameter of the aperture hole 6b, the suction range A1 of the stamper 61 is gradually expanded in diameter from the central portion of the stamper 61 toward the outer periphery thereof. During this process, as shown in FIGS. 7 and 8, along with the expansion of the diameter of the suction range A1, the stamper 61 is gradually drawn into the space SP, whereby the removal completion range of the stamper 61 is gradually increased. Further, the stamper 61 removed from the resist layer 52 is drawn to the upward motion-restricting plate 6c within the space SP, whereby a further upward motion thereof is restricted. At this time, in an imprinting apparatus configured not to include the upward motion-restricting plate 6c, there is a concern that the central portion of the sucked stamper 61 is deformed by being sucked into the space SP in a manner protruding upward considerably far from the stamper 61. On the contrary, in the imprinting apparatus 1, an extreme upward motion of the stamper 61 is restricted by the upward motion-restricting plate 6c to thereby avoid the deformation of the stamper 61. This makes it possible to avoid breakage of the stamper 61.

After that, as shown in FIG. 9, when the suction range A1 is expanded to the whole area of the stamper 61, the whole of the stamper 61 is removed from the resist layer 52 (the removal completion range of the stamper 61 is expanded all over the stamper 61). Then, the control section 7 causes the moving mechanism 3 to retract the suction section 4 from the position over the disk-shaped substrate 51. This completes the removal of the stamper 61 from the resist layer 52, and the mask made of the resist layer 52 is formed on the disk-shaped substrate 51. After that, the disk-shaped substrate 51 is subjected to the etching process using the mask formed on the disk-shaped substrate 51, thereby the nanometer-sized fine concave/convex pattern is formed on the one surface of the disk-shaped substrate 51. It should be noted that detailed description of the etching process is omitted since it is a known technique.

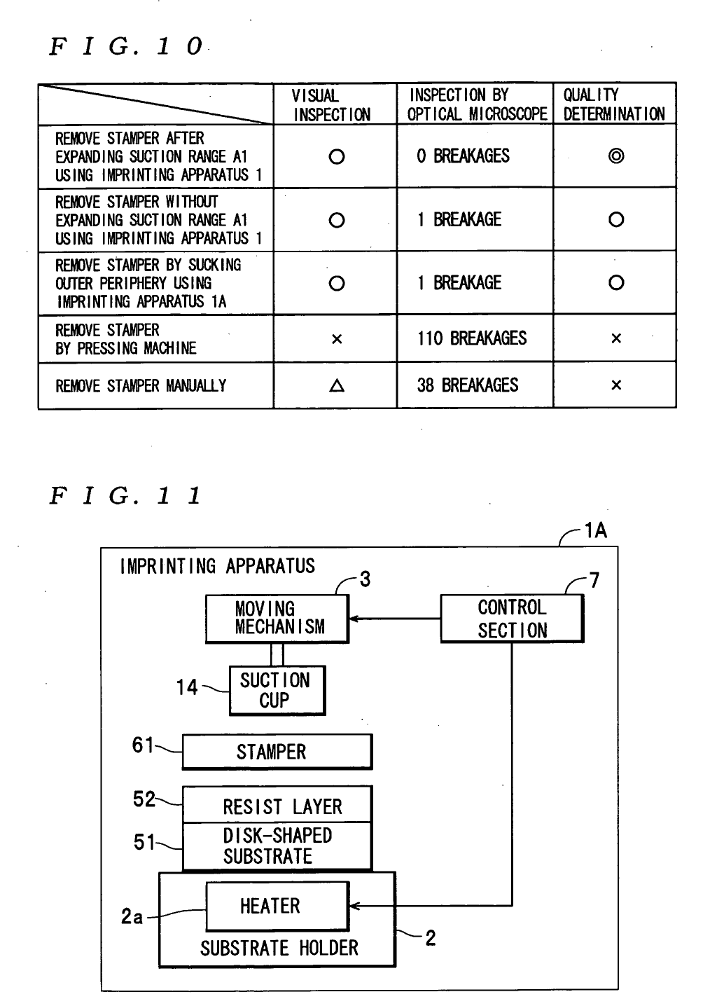

In this case, as shown in FIG. 10, when the stamper 61 is removed from the resist layer 52 by the removing method using the imprinting apparatus 1 (in which the suction range A1 of the stamper 61 is gradually expanded by gradually expanding the diameter of the aperture hole 6b to thereby expand the removal completion range of the stamper 61), no breakage is recognized in the resist layer 52 by either visual inspection or inspection using a microscope. On the other hand, when a stamper is removed from a resist layer by the conventional removing method in which the clamp of the pressing machine is moved upward to remove the whole of the stamper from the resin layer almost simultaneously, breakages are recognized in the resist layer by visual inspection, and 110 breakages of the concave/convex pattern are recognized in a predetermined inspection area by inspection using a microscope. Further, when the stamper 61 is removed manually, a slight amount of breakage is recognized in the resist layer by visual inspection, and 38 breakages of the concave/convex pattern are recognized in the predetermined inspection area by inspection using a microscope. Therefore, to form a mask while preventing breakage of the concave/convex pattern, it is preferable that the stamper 61 is removed from the resist layer 52 by the removing method described in the present embodiment.

As described above, according to the imprinting method by the imprinting apparatus 1, air within the space SP is sucked by the air pump 5, thereby the central portion of the other surface of the stamper 61 is sucked via the aperture hole 6b of the restrictor 6 to remove the central portion of the stamper 61 from the resist layer 52, and then the removal completion range of the stamper 61 is gradually expanded to remove the stamper 61 from the resist layer 52, whereby it is possible to remove the stamper 61 from the resist layer 52 with a relatively small force, unlike the removing method of removing the whole of the stamper 61 from the resist layer 52 all at once using e.g., a pressing machine. Further, by gradually expanding the removal completion range (suction range A1), it is possible to remove the stamper 61 from the resist layer 52 without applying an undue force to the resist layer 52, thereby making it possible to avoid breakage of the concave/convex pattern during the removal of the stamper 61. Therefore, e.g., when the disk-shaped substrate 51 is subjected to the etching process using the resist layer 52 as a mask, the one surface of the disk-shaped substrate 51 which is to be protected by the mask (resist layer 52) can be reliably protected.

Further, according to the imprinting apparatus 1, the suction section 4 is configured to be capable of sucking the central portion of the other surface of the stamper 61 as the predetermined part in the present invention, thereby no inconvenience is caused during recording and reproducing of information even if small defects have occurred in a central portion of information recording media (information recording media including magnetic recording media, such as a discrete track-type recording medium, optical recording media, such as a CD-R, and magneto-optical recording media, such as an MO) as bodies of rotation, so that even if the concave/convex pattern on the central portion of the disk-shaped substrate 51 is slightly damaged in an initial stage of removal operation for removing the stamper 61, it is possible to manufacture information recording media enabling accurate reading and writing of information.

Furthermore, the imprinting apparatus 1 is configured such that the suction range A1 of the stamper 61 can be steplessly and gradually expanded toward the outer periphery of the stamper 61 in the state of the central portion thereof being sucked, whereby even if a very small breakage which presents almost no problem in use has occurred in the concave/convex pattern during the removal of the stamper 61, it is possible to preserve uniformity of the state of occurrence of the small breakage at portions equal in radial distance from the central portion of the disk-shaped substrate 51. This makes it possible to form a concave/convex pattern suitable for manufacturing information recording media as bodies of rotation, such as magnetic disks, optical disks, and magneto-optical disks.

Further, the imprinting apparatus 1 is configured such that air between the stamper 61 and the restriction blades 6a, 6a, . . . is sucked by the air pump 5 through the aperture hole 6b of the restrictor 6, thereby the central portion of the stamper 61 is sucked, and then by sliding the restriction blades 6a, 6a, . . . , the diameter of the aperture hole 6b is gradually expanded so as to enable the suction range A1 to be gradually expanded toward the outer periphery of the stamper. Although relatively simple, this configuration of the apparatus 1 makes it possible to reliably and easily adjust the removal completion range of the stamper 61.

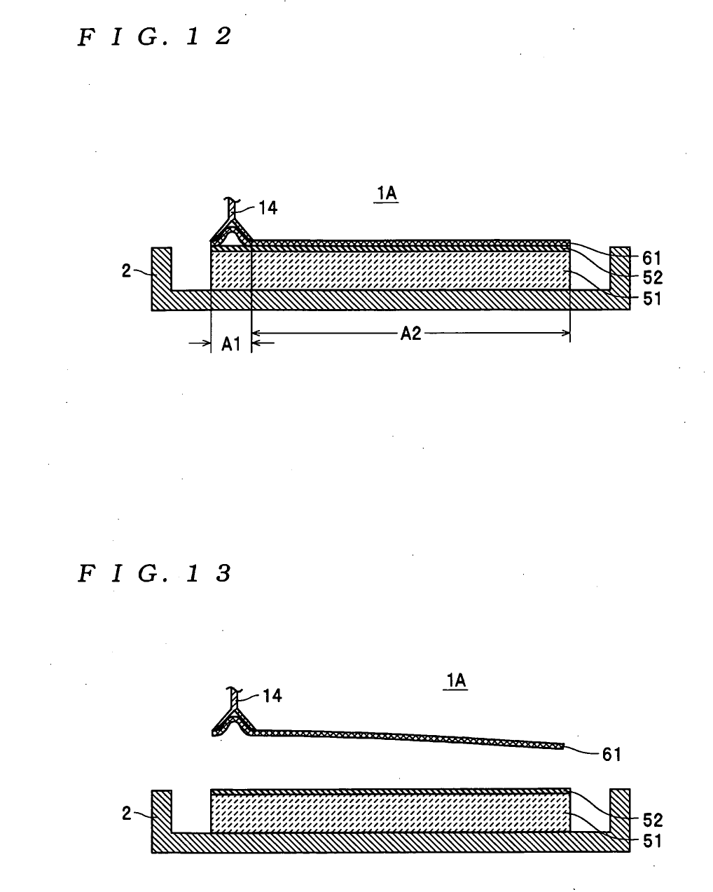

It should be noted that the present invention is by no means limited to the aforementioned embodiment. For example, although in the above-described embodiment of the present invention, the description has been given of the example in which the imprinting apparatus 1 includes the suction section 4, the air pump 5, and the restrictor 6 to construct the suction device in the present invention, this is not limitative, but it is possible to construct the suction device in the present invention by a suction cup 14 as in an imprinting apparatus 1A shown in FIG. 11. It should be noted that component elements common to those of the imprinting apparatus 1 will be assigned identical reference numerals, and description thereof is omitted. In the imprinting apparatus 1A, the suction cup 14 is mounted on the moving mechanism 3 in place of the suction section 4 in the imprinting apparatus 1. In removing the stamper 61 from the resist layer 52 by the imprinting apparatus 1A, first, the suction cup 14 is moved downward by the moving mechanism 3 toward the outer periphery of the other surface of the stamper 61 (moved in a direction approaching the resist layer 52), and pressed against the stamper 61. At this time, as shown in FIG. 12, the outer periphery (an example of “the predetermined part” in the present invention) of the stamper 61 is sucked upward by the suction force of the suction cup 14, and removed from the resist layer 52 within the suction range A1. Then, the control section 7 causes the moving mechanism 3 to move the suction cup 14 upward (in a direction away from the resist layer 52), thereby the stamper 61 in a state sucked by the suction cup 14 is gradually removed from the resist layer 52 to expand the removal completion range. Thus, as shown in FIG. 13, the removal of the stamper 61 from the resist layer 52 is completed.

In this case, when the stamper 61 is removed by the imprinting apparatus 1A, ambient air is allowed to smoothly flow in between the stamper 61 and the resist layer 52 along with an upward motion of the suction cup 14 by the moving mechanism 3. Therefore, it is possible to remove the stamper 61 from the resist layer 52 with a relatively small force, unlike the removing method of removing the whole of the stamper 61 from the resist layer 52 all at once using the pressing machine. Since this makes it possible to remove the stamper 61 from the resist layer 52 without applying an undue force to the resist layer 52, it is possible to avoid breakage of the concave/convex pattern during the removal of the stamper 61. More specifically, as shown in FIG. 10, when the stamper 61 is removed from the resist layer 52 by a removing method using the imprinting apparatus 1A (in which in the state of the stamper 61 having the outer periphery thereof sucked by the suction cup 14, the suction cup 14 is moved upward without expanding the suction range A1), no breakage is recognized in the resist layer 52 by visual inspection. Further, only one breakage of the concave/convex pattern is recognized in the predetermined inspection area in the resist layer 52 from which the stamper 61 is removed by this method. Accordingly, similarly to the imprinting apparatus 1, it is possible to remove the stamper 61 with a small force, and avoid breakage of the concave/convex pattern during the removal of the stamper 61. Further, since the suction cup 14 is inexpensive, the imprinting apparatus 1A can be manufactured sufficiently inexpensively. It should be noted that in the aforementioned imprinting apparatus 1, also when the stamper 61 is removed without sliding the restriction blades 6a, 6a, . . . of the restrictor 6 (without expanding the suction range A1) in a state where the diameter of the aperture hole 6b is held minimum, the same result as that of the removal of the stamper 61 performed using the suction cup 14 is recognized. Further, in the imprinting apparatus 1A, it is also possible to press the suction cup 14 against the central portion of the other surface of the stamper 61, move the suction cup 14 upward by the moving mechanism 3 after removing the central portion of the stamper 61 by the suction force of the suction cup 14, and gradually expand the removal completion range. In this case as well, the same result is recognized.

Further, although in the above-described embodiment of the present invention, the description has been given of the example in which the diameter of the aperture hole 6b is steplessly expanded to steplessly and gradually expand the suction range A1 of the stamper 61, this is not limitative, but it is also possible to employ an adjustment method in which the restriction blades 6a, 6a, . . . are stepwise slid to expand the diameter of the aperture hole 6b in multiple steps, whereby the suction range A1 of the stamper 61 is gradually expanded in multiple steps. Furthermore, although in the above-described embodiment of the present invention, the description has been given of the removing method in which the suction range A1 is gradually expanded from the central portion of the stamper 61 toward the outer periphery thereof, by way of example, this is not limitative, but it is also possible to employ a configuration in which the suction range A1 is gradually expanded toward the central portion of the stamper 61 in a state in which the whole or at least part of the outer periphery of the stamper 61 is sucked (the whole means an annular area, for example). According to this configuration, it is possible to cause ambient air to smoothly flow in between the stamper 61 and the resist layer 52, thereby making it possible to remove the stamper 61 with a smaller force and reliably avoid breakage of the concave/convex pattern during the removal of the stamper 61.

Further, although in the above-described embodiment of the present invention, the description has been given of the configuration in which the upward motion-restricting plate 6c is disposed in the restrictor 6, the upward motion-restricting plate 6c is not necessarily required, but if the box body 4a is shallow plate-shaped, it is also possible to employ a configuration in which the sucked stamper 61 is brought into abutment with the inner bottom surface of the box body 4a. Furthermore, it is also possible to use the imprinting apparatuses 1 or 1A placed upside down. In this case, by disposing a device to hold the disk-shaped substrate 51 (e.g., a suction section for sucking the disk-shaped substrate 51) in the substrate holder 2, it is possible to avoid the disk-shaped substrate 51 being dropped. Further, although in the above-described embodiment of the present invention, the description has been given of the example in which the concave/convex pattern is transferred to the resist layer 52 applied to one surface of the disk-shaped substrate 51, the resin layer in the present invention is not limited to a layer made of a resist material, but the resin layer can be formed by applying one of various types of resin materials to the substrate in the form of a thin film. Furthermore, the disk-shaped substrate 51 as well is not limited to a substrate for information recording media, but the substrate in the present invention includes substrates e.g., for manufacturing semiconductor devices. Additionally, the resin layer to which the concave/convex pattern is transferred is not limited to the resin layer (resist layer 52) for forming a mask described in the present embodiment, but the resin layer in the present invention includes resin layers (resist layers) for forming a substrate for so-called lift-off, and a substrate for forming a nickel stamper, and so forth.

### INDUSTRIAL APPLICABILITY

As described hereinabove, according to the imprinting apparatus, a predetermined part of the other surface of a stamper is caused to be sucked by a suction device, and a removal completion range is gradually expanded from a state of the portion being removed from a resin layer, whereby it is possible to easily remove a stamper without a hole from the resin layer with a relatively small force, unlike a removing method of removing the whole of a stamper from a resin layer all at once using a pressing machine, for example. Further, since gradual expansion of the removal completion range (suction range) makes it possible to remove the stamper from the resin layer without applying an undue force to the resin layer, it is possible to avoid breakage of a concave/convex pattern during the removal of the stamper. Therefore, e.g., when a substrate is subjected to the etching process using the resin layer as a mask, it is possible to reliably protect one surface of the substrate which is to be protected by the mask (resin layer). Thus, an imprinting apparatus is realized which is capable of easily removing a stamper without a hole from a resin layer without causing breakage of a concave/convex pattern.

1. An imprinting apparatus configured to be capable of removing a stamper having one surface thereof formed with a concave/convex portion and having flexibility, from a resin layer to which shapes of the concave/convex portion have been transferred by pressing the concave/convex portion of the stamper against the resin layer on a substrate,
wherein the imprinting apparatus comprises a suction device configured to be capable of sucking a predetermined part of the other surface of the stamper to thereby remove the predetermined part from the resin layer, such that a removal completion range of the stamper can be gradually expanded from a state where the predetermined part is removed from the resin layer by the suction device.

2. An imprinting apparatus according to claim 1, wherein the suction device is configured to be capable of sucking a central portion of the other surface of the stamper as the predetermined part.

3. An imprinting apparatus according to claim 2, wherein the suction device is configured to be capable of gradually expanding the removal completion range toward an outer periphery of the stamper by gradually expanding a suction range of the stamper toward the outer periphery in multiple steps or steplessly in a state where the suction device has sucked the central portion thereto.

4. An imprinting apparatus according to claim 3, wherein the suction device comprises a box body with one surface thereof opened, and a restrictor having a plurality of restriction blades and mounted on the box body in a manner closing the one surface of the box body, and the suction device is configured to be positioned above the stamper during removal of the stamper, sucks the central portion of the stamper by sucking gas between the stamper and the restriction blades through an aperture hole of the restrictor, and gradually expands a diameter of the aperture hole by sliding the restriction blades in the state where the suction device has sucked the central portion of the stamper thereto, whereby the suction device is capable of gradually expanding the suction range toward the outer periphery of the stamper.

5. An imprinting apparatus according to claim 1, wherein the suction device is configured to be capable of sucking at least a portion of the outer periphery of the other surface of the stamper as the predetermined part.

6. An imprinting apparatus according to claim 5, wherein the suction device is configured to be capable of gradually expanding the removal completion range toward the central portion of the stamper by gradually expanding a suction range of the stamper toward the central portion in multiple steps or steplessly in a state where the suction device has sucked the outer periphery thereto.

7. An imprinting apparatus according to claim 1, comprising a suction cup as the suction device, and a moving mechanism for moving the suction cup, and the moving mechanism is configured such that the moving mechanism causes the suction cup to suck the predetermined part by pressing the suction cup against the other surface of the stamper, to thereby remove the predetermined part from the resin layer, and moves the suction cup in a direction away from the resin layer from the state where the suction cup has removed the predetermined part from the resin layer, whereby the moving mechanism is capable of gradually expanding the removal completion range of the stamper.

8. An imprinting method wherein a stamper having one surface thereof formed with a concave/convex portion and having flexibility is removed from a resin layer to which shapes of the concave/convex portion have been transferred by pressing the concave/convex portion of the stamper against the resin layer on a substrate,
the method comprising gradually expanding a removal completion range of the stamper after removing a predetermined part of the other surface of the stamper from the resin layer by sucking the predetermined part.
